(19) United States
(12) Patent Application Publication
(10) Pub. No.: US 2020/0262418 A1
(43) Pub. Date: Aug. 20, 2020

(54) MOVING CONTROL METHOD, APPARATUS, AND SYSTEM

(71) Applicant: HUAWEI TECHNOLOGIES CO., LTD., Shenzhen (CN)

(72) Inventor: Yangbo LIN, Shenzhen (CN)

(21) Appl. No.: 16/869,975

(22) Filed: May 8, 2020

Related U.S. Application Data
(63) Continuation of application No. PCT/CN2018/094134, filed on Jul. 2, 2018.

(30) Foreign Application Priority Data
Nov. 8, 2017 (CN) 201711092225.4

(51) Int. Cl. B60W 30/06; G05D 1/02; G08G 1/14; G08G 1/16; B60W 30/095

(52) U.S. Cl. CPC B60W 30/06; G05D 1/0276; G08G 1/141; G05D 2201/0213; G08G 1/166; B60W 30/0956; G08G 1/168

(57) ABSTRACT

The method includes: determining predicted moving space of a target vehicle and predicted moving space of a target object during a parking period of the target vehicle; if the predicted moving space of the target vehicle overlaps with predicted moving space of at least one target object, determining, as a conflicting target object, the target object whose predicted moving space overlaps with that of the target vehicle; and determining moving priorities of the target vehicle and the conflicting target object according to a preset rule, and sending a moving order coordination instruction to the target vehicle and the conflicting target object based on the moving priorities. The target vehicle and the target object are scheduled in a coordinated manner, so that improving parking safety and efficiency.

### CROSS-REFERENCE TO RELATED APPLICATIONS

This application is a continuation of International Application No. PCT/CN2018/094134, filed on Jul. 2, 2018, which claims priority to Chinese Patent Application No. 201711092225.4, filed on Nov. 8, 2017. The disclosures of the aforementioned applications are hereby incorporated by reference in their entireties.

### TECHNICAL FIELD

Embodiments of this application relate to the field of transportation technologies, and in particular, to a moving control method, apparatus, and system.

### BACKGROUND

When driving a vehicle to a vicinity of a destination, a driver usually searches for an appropriate parking lot for parking. After finishing parking, the driver may get out the vehicle and walk to the final destination.

Cities are increasingly crowed nowadays, and there are constantly vehicles and pedestrians near each parking place. When a vehicle is to be parked, if the to-be-parked vehicle and vehicles and pedestrians near the to-be-parked vehicle all plan their moving routes on their own, it is highly likely that these moving routes overlap. Consequently, a collision may happen between the to-be-parked vehicle and the vehicles or the pedestrians, resulting in relatively low parking safety.

### SUMMARY

Embodiments of this application provide a moving control method, apparatus, and system, to resolve a problem of relatively low parking safety in the prior art.

According to a first aspect, a moving control method is provided, where the method includes:

determining predicted moving space of a target vehicle and predicted moving space of a target object during a parking period of the target vehicle, where the target object is an object whose distance from the target vehicle is less than a preset threshold;

if the predicted moving space of the target vehicle overlaps with predicted moving space of at least one target object, determining, as a conflicting target object, the target object whose predicted moving space overlaps with that of the target vehicle; and

determining moving priorities of the target vehicle and the conflicting target object according to a preset rule, and sending a moving order coordination instruction to the target vehicle and the conflicting target object based on the moving priorities.

The target vehicle and the target object are scheduled in a coordinated manner, so that the target vehicle and the target object can avoid a collision between a to-be-parked vehicle and a vehicle or a pedestrian caused by a lack of knowledge of each other's planned moving route, thereby improving parking safety and efficiency.

In a possible implementation, the determining predicted moving space of a target vehicle during a parking period of the target vehicle includes:

receiving the predicted moving space that is of the target vehicle during the parking period of the target vehicle and that is sent by the target vehicle; or

receiving a predicted moving track of the target vehicle during the parking period of the target vehicle and a vehicle size of the target vehicle that are sent by the target vehicle, and determining the predicted moving space of the target vehicle during the parking period of the target vehicle based on the predicted moving track and the vehicle size of the target vehicle; or

receiving parking related information of the target vehicle sent by the target vehicle, where the parking related information of the target vehicle includes one or more of a parking space direction, target vehicle information, obstacle information, and target parking space information, the target vehicle information includes an identifier of the target vehicle or a location and a size of the target vehicle, the obstacle information includes an identifier of an obstacle or a location and a size of an obstacle, and the target parking space information includes an identifier of a target parking space or a location and a size of a target parking space; and determining the predicted moving space of the target vehicle during the parking period of the target vehicle based on the parking related information of the target vehicle.

Instead of directly sending the predicted moving space of the target vehicle during the parking period of the target vehicle to a management device, the target vehicle sends, to the management device, all information used to determine the predicted moving space of the target vehicle during the parking period of the target vehicle, and the management device determines the predicted moving space of the target vehicle during the parking period of the target vehicle based on the information. Alternatively, the target vehicle may directly send the determined predicted moving space to the management device.

In a possible implementation, the determining predicted moving space of a target object during a parking period of the target vehicle includes:

receiving the predicted moving space that is of the target object during the parking period of the target vehicle and that is sent by the target object; or

receiving a predicted moving track of the target object during the parking period of the target vehicle and a size of the target object that are sent by the target object, and determining the predicted moving space of the target object during the parking period of the target vehicle based on the predicted moving track and the size of the target object; or

receiving moving related information of the target object sent by the target object, where the moving related information of the target object includes a moving destination location and target object information, and the target object information includes an identifier of the target object or a location and a size of the target object, and determining the predicted moving space of the target object during the parking period of the target vehicle based on the moving related information of the target object.

Instead of directly sending the predicted moving space of the target vehicle during the parking period of the target vehicle to a management device, the target object sends, to the management device, all information used to determine the predicted moving space of the target vehicle during the parking period of the target vehicle, and the management device determines the predicted moving space of the target vehicle during the parking period of the target vehicle based on the information. Alternatively, the target object may directly send the determined predicted moving space to the management device.

In a possible implementation, the target object includes a pedestrian and a vehicle, and the preset rule includes at least one of the following rules, and a preset priority of each rule:

a moving priority of the pedestrian is higher than that of the vehicle;

a moving priority of a vehicle driving out of a parking space is higher than that of a vehicle driving into a parking space;

a moving priority of a disabled pedestrian is higher than that of a non-disabled pedestrian;

a moving priority of an emergency vehicle is higher than that of a non-emergency vehicle;

a moving priority of a public vehicle is higher than that of a non-public vehicle; and moving priorities of pedestrians with a same attribute or vehicles with a same attribute are randomly allocated.

In a possible implementation, the sending a moving order coordination instruction to the target vehicle and the conflicting target object based on the moving priorities includes:

sending a suspend-parking instruction to the target vehicle when a moving priority of any about-to-move conflicting target object of the conflicting target object is higher than that of the target vehicle; and

sending a continue-parking instruction to the target vehicle after all conflicting target objects of the conflicting target object whose moving priorities are higher than that of the target vehicle have moved out of the predicted moving space of the target vehicle.

The target vehicle and the target object are scheduled in a coordinated manner, so that the target vehicle and the target object can avoid a collision between a to-be-parked vehicle and a vehicle or a pedestrian caused by a lack of knowledge of each other's planned moving route, thereby improving parking safety and efficiency.

In a possible implementation, the method further includes:

when receiving a parking start notification sent by the target vehicle, sending, to the target object or the conflicting target object, a reminder indicating that parking of the target vehicle starts; or starting to send, to the target object or the conflicting target object according to a predetermined cycle, a reminder indicating that the target vehicle is being parked.

The parking start notification is sent to the target object to remind the target object.

In a possible implementation, the method further includes:

when receiving a parking end notification sent by the target vehicle, sending, to the target object or the conflicting target object, a reminder indicating that parking of the target vehicle ends; or stopping sending, to the target object or the conflicting target object according to a predetermined cycle, a reminder indicating that the target vehicle is being parked.

According to a second aspect, a moving control method is provided, where the method includes:

receiving, during a parking period of a target vehicle, a moving order coordination instruction sent by a management device, and performing parking processing according to the moving order coordination instruction.

The target vehicle and a target object are scheduled in a coordinated manner, so that the target vehicle and the target object can avoid a collision between a to-be-parked vehicle and a vehicle or a pedestrian caused by a lack of knowledge of each other's planned moving route, thereby improving parking safety and efficiency.

In a possible implementation, the method further includes:

sending predicted moving space of the target vehicle during the parking period of the target vehicle to the management device, where the predicted moving space of the target vehicle is determined based on parking related information of the target vehicle, the parking related information of the target vehicle includes one or more of a parking space direction, target vehicle information, obstacle information, and target parking space information, the target vehicle information includes a location and a size of the target vehicle, the obstacle information includes a location and a size of an obstacle, and the target parking space information includes a location and a size of a target parking space; or

sending a predicted moving track of the target vehicle during the parking period of the target vehicle and a size of the target vehicle to the management device, where the predicted moving track of the target vehicle is determined based on one or more of a parking space direction of the target vehicle, a location of the target vehicle, obstacle information, and target parking space information; or

sending parking related information of the target vehicle during the parking period of the target vehicle to the management device, where the parking related information of the target vehicle includes one or more of a parking space direction, target vehicle information, obstacle information, and target parking space information, the target vehicle information includes an identifier of the target vehicle or a location and a size of the target vehicle, the obstacle information includes an identifier of an obstacle or a location and a size of an obstacle, and the target parking space information includes an identifier of a target parking space or a location and a size of a target parking space.

Instead of directly sending the predicted moving space of the target vehicle during the parking period of the target vehicle to the management device, the target vehicle sends, to the management device, all information used to determine the predicted moving space of the target vehicle during the parking period of the target vehicle, and the management device determines the predicted moving space of the target vehicle during the parking period of the target vehicle based on the information. Alternatively, the target vehicle may directly send the determined predicted moving space to the management device.

In a possible implementation, the receiving, during a parking period of a target vehicle, a moving order coordination instruction sent by a management device, and performing parking processing according to the moving order coordination instruction includes:

during the parking period of the target vehicle, suspending parking when a suspend-parking instruction sent by the management device is received; and

during the parking period of the target vehicle, continuing parking when a continue-parking instruction sent by the management device is received.

In a possible implementation, the method further includes:

sending a parking start notification to the management device when the target vehicle starts a parking operation.

The parking start notification is sent to the management device, so that the management device reminds another transportation participant.

In a possible implementation, the method further includes:

sending a parking end notification to the management device when the target vehicle ends a parking operation.

The parking end notification is sent to the management device, so that the management device reminds another transportation participant.

According to a third aspect, a moving control apparatus is provided, where the apparatus includes at least one module, and the at least one module is configured to implement the moving control method according to the first aspect.

According to a fourth aspect, a moving control apparatus is provided, where the apparatus includes at least one module, and the at least one module is configured to implement the moving control method according to the second aspect.

According to a fifth aspect, a moving control system is provided, where the system includes a management device and a target vehicle:

the management device is configured to determine predicted moving space of the target vehicle and predicted moving space of a target object during a parking period of the target vehicle, where the target object is an object whose distance from the target vehicle is less than a preset threshold; if the predicted moving space of the target vehicle overlaps with predicted moving space of at least one target object, determine, as a conflicting target object, the target object whose predicted moving space overlaps with that of the target vehicle; and determine moving priorities of the target vehicle and the conflicting target object according to a preset rule, and send a moving order coordination instruction to the target vehicle and the conflicting target object based on the moving priorities; and

the target vehicle is configured to receive, during the parking period of the target vehicle, the moving order coordination instruction sent by the management device, and perform parking processing according to the moving order coordination instruction.

According to a sixth aspect, a management device is provided, where the management device includes a processor, a memory, and a transmitter, the processor is configured to execute an instruction stored in the memory, and the processor implements the moving control method according to the first aspect by executing the instruction.

According to a seventh aspect, a target vehicle is provided, where the target vehicle includes a receiver and a processor, the processor is configured to execute an instruction stored in a memory, and the processor implements the moving control method according to the second aspect by executing the instruction.

According to an eighth aspect, a computer readable storage medium including an instruction is provided, where when the instruction is run on a management device, the management device is enabled to perform the method according to the first aspect.

According to a ninth aspect, a computer program product including an instruction is provided, where when the computer program product is run on a management device, the management device is enabled to perform the method according to the second aspect.

According to a tenth aspect, a computer readable storage medium including an instruction is provided, where when the instruction is run on a target vehicle, the target vehicle is enabled to perform the method according to the second aspect.

According to an eleventh aspect, a computer program product including an instruction is provided, where when the computer program product is run on a target vehicle, the target vehicle is enabled to perform the method according to the second aspect.

Technical effects obtained in the third aspect to the eleventh aspect of the embodiments of this application are similar to technical effects obtained by using corresponding technical means in the first aspect and the second aspect. Details are not described herein again.

In comparison with the prior art, in the solutions provided in the embodiments of this application, the target vehicle and the target object are scheduled in a coordinated manner, so that the target vehicle and the target object can avoid a collision between a to-be-parked vehicle and a vehicle or a pedestrian caused by a lack of knowledge of each other's planned moving route, thereby improving parking safety and efficiency.

### BRIEF DESCRIPTION OF DRAWINGS

The accompanying drawings herein are incorporated in the specification as a part of the specification, show embodiments that are in accordance with this application, and are used together with the specification to explain a principle of this application. In the accompanying drawings:

FIG. 1-A is a schematic structural diagram of a management device according to an example embodiment;

FIG. 1-B is a schematic structural diagram of a target vehicle according to an example embodiment;

FIG. 2 is a schematic flowchart of a moving control method according to an example embodiment:

FIG. 3-A is a schematic diagram of a moving control scenario according to an example embodiment;

FIG. 3-B is a schematic diagram of a moving control scenario according to an example embodiment;

FIG. 3-C is a schematic diagram of a moving control scenario according to an example embodiment:

FIG. 4 is a schematic diagram of a moving control scenario according to an example embodiment:

FIG. 5 is a schematic structural diagram of a moving control apparatus according to an example embodiment; and

FIG. 6 is a schematic structural diagram of a moving control apparatus according to an example embodiment.

The foregoing accompanying drawings show specific embodiments of this application, and more detailed descriptions are provided below. The accompanying drawings and text descriptions are not intended to limit the scope of the idea of this application in any manner, but are intended to describe the concept of this application to a person skilled in the art with reference to particular embodiments.

### DESCRIPTION OF EMBODIMENTS

To make the objectives, technical solutions, and advantages of this application clearer, the following further describes the implementations of this application in detail with reference to the accompanying drawings.

An embodiment of this application provides a moving control method. The method is performed by a management device. In a process of implementing the method, in addition to the management device, a target vehicle and another transportation participant may be involved in implementation. The management device may be deployed in a remote cloud, a central control room near a parking place, or a mobile device near a parking place. This is not limited in this embodiment of this application.

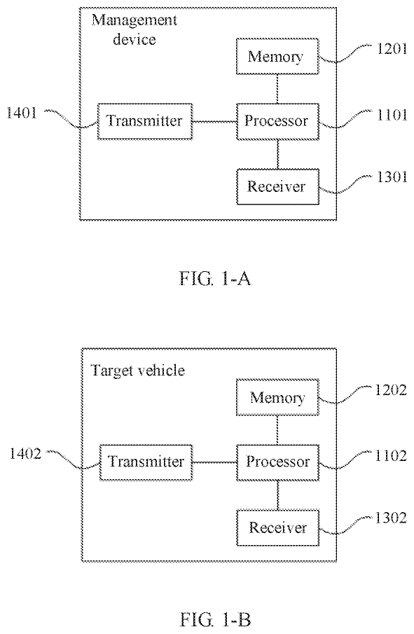

The management device may include a processor 1101 and a memory 1201, and the processor 1101 may be connected to the memory 1201, as shown in FIG. 1-A. The processor 1101 may include one or more processing units. The processor 1101 may be a general purpose processor, including a central processing unit (CPU), a network processor (NP), or the like, or may be a digital signal processor (DSP), an application-specific integrated circuit (ASIC), a field programmable gate array (FPGA) or another programmable logic device, or the like. Specifically, a program may include program code, and the program code includes a computer operation instruction. The management device may further include the memory 1201. The memory 1201 may be configured to store a software program and a module. The processor 1101 reads software code and the module that are stored in the memory 1201, to execute a task. In addition, the management device may further include a receiver 1301 and a transmitter 1401. Both the receiver 1301 and the transmitter 1401 may be connected to the processor 1101. The transmitter 1401 and the receiver 1301 may be collectively referred to as a transceiver. The transmitter 1401 may be configured to send a message or data. The transmitter 1401 may include but is not limited to at least one amplifier, a tuner, one or more oscillators, a coupler, an Low Noise Amplifier (LNA), a duplexer, and the like.

The target vehicle may include a processor 1102 and a memory 1202, and the processor 1102 may be connected to the memory 1202, as shown in FIG. 1-B. The processor 1102 may include one or more processing units. The processor 1102 may be a general purpose processor, including a central processing unit (CPU), a network processor (NP), or the like, or may be a digital signal processor (DSP), an application-specific integrated circuit (ASIC), a field programmable gate array (FPGA) or another programmable logic device, or the like. Specifically, a program may include program code, and the program code includes a computer operation instruction. The target vehicle may further include the memory 1202. The memory 1202 may be configured to store a software program and a module. The processor 1102 reads software code and the module that are stored in the memory 1202, to execute a task. In addition, the target vehicle may further include a receiver 1302 and a transmitter 1402. Both the receiver 1302 and the transmitter 1402 may be connected to the processor 1102. The transmitter 1402 and the receiver 1302 may be collectively referred to as a transceiver. The transmitter 1402 may be configured to send a message or data. The transmitter 1402 may include but is not limited to at least one amplifier, a tuner, one or more oscillators, a coupler, an Low Noise Amplifier (LNA), a duplexer, and the like.

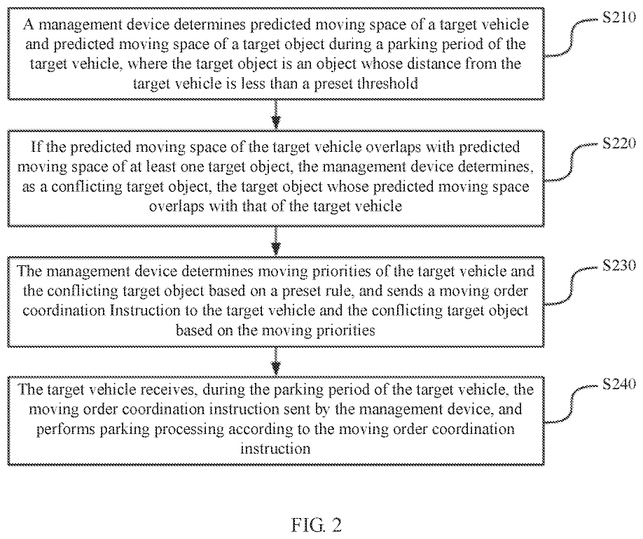

Automatic parking function-based parking of a target vehicle is used as a specific implementation below to describe a processing procedure in FIG. 2 in detail. Details may be as follows.

Step S210. A management device determines predicted moving space of the target vehicle and predicted moving space of a target object during a parking period of the target vehicle, where the target object is an object whose distance from the target vehicle is less than a preset threshold.

In implementation, before determining whether the predicted moving space of the target vehicle overlaps with the predicted moving space of the target object, the management device may first determine an object whose distance from the target vehicle is less than the preset threshold. The preset threshold may be set to 30 m, a length of six parking spaces, or the like. After the object whose distance from the target vehicle is less than the preset threshold is determined, predicted moving space of the object may be determined.

In a specific application scenario, when a driver drives a vehicle to a vicinity of a parking place and needs to park the vehicle in a target parking space, an automatic parking instruction may be triggered and generated, so that the vehicle is automatically parked in the target parking space. Specifically, in a vehicle with an automatic parking function, a dedicated automatic parking button may be provided, or a key for enabling an automatic parking function may be provided under a function menu of the vehicle on a vehicular human-vehicle interaction interface. When it is detected that a driver presses the button or taps the key, an automatic parking instruction may be sent to a controller of the vehicle. When the controller of the vehicle detects the automatic parking instruction, it may be considered that an automatic parking trigger event is detected. The target vehicle is a to-be-parked vehicle and may send a parking request to the management device. Alternatively, when detecting that any vehicle driving into a managed area such as a parking lot is near a parking space, the management device may trigger an operation of determining the predicted moving space of the target vehicle and predicted moving space of at least one target object during the parking period of the target vehicle.

This embodiment provides three ways of determining the predicted moving space of the target vehicle during the parking period of the target vehicle.

(1) Receive the predicted moving space that is of the target vehicle during the parking period of the target vehicle and that is sent by the target vehicle.

In this case, the target vehicle may send the predicted moving space of the target vehicle during the parking period of the target vehicle to the management device. The predicted moving space of the target vehicle is determined based on parking related information of the target vehicle, and the parking related information of the target vehicle sent by the target vehicle is received. The parking related information of the target vehicle includes one or more of a parking space direction, target vehicle information, obstacle information, and target parking space information, the target vehicle information includes a location and a size of the target vehicle, the obstacle information includes a location and a size of an obstacle, and the target parking space information includes a location and a size of a target parking space.

For the parking related information, if there is an obstacle around the target vehicle, the obstacle needs to be considered when the predicted moving space of the target vehicle is determined. To be specific, an obstacle around a vehicle body needs to be detected, so that the finally determined predicted moving space does not include space occupied by the obstacle. If there is no obstacle, there is no need to obtain obstacle information.

The parking space direction of the target vehicle may be selected by a driver on a vehicular human-vehicle interaction interface, or may be a default orientation set in an automatic parking system of the target vehicle. When parked into the target parking space, the target vehicle is parked in the determined parking space direction. A current orientation of the target vehicle may be selected by the driver on the vehicular human-vehicle interaction interface, or may be automatically detected by the target vehicle. A current vehicle location of the target vehicle may be determined through positioning. The obstacle information may be circumstances related to obstacles around the target vehicle and the target parking space. When the target vehicle is parked, these obstacles need to be avoided. The target parking space information may be the location of the target parking space and an orientation of the target parking space (including a length and a width). The obstacle information and the target parking space information may be determined through detection by the target vehicle by using a detector installed on the target vehicle.

After determining a predicted moving track based on the parking space direction, the current vehicle location, the obstacle information, and the target parking space information of the target vehicle, the target vehicle may further determine the predicted moving space of the target vehicle during the parking period of the target vehicle based on an outline size of the vehicle. After determining the predicted moving space of the target vehicle during the parking period of the target vehicle, the target vehicle may send the predicted moving space to the management device. The management device may directly use information about the predicted moving space that is of the target vehicle during the parking period of the target vehicle and that is determined by the target vehicle.

(2) Receive a predicted moving track of the target vehicle during the parking period of the target vehicle and a size of the target vehicle that are sent by the target vehicle, and determine the predicted moving space of the target vehicle during the parking period of the target vehicle based on the predicted moving track and the size of the target vehicle.

In this case, the target vehicle may send the predicted moving track of the target vehicle during the parking period of the target vehicle and the size of the target vehicle to the management device. The predicted moving track of the target vehicle is determined based on one or more of a parking space direction of the target vehicle, a location of the target vehicle, obstacle information, and target parking space information.

The target vehicle may first determine the predicted moving track of the target vehicle during the parking period of the target vehicle, and send the moving track together with the size of the target vehicle to the management device; and then the management device determines the final predicted moving space of the target vehicle during the parking period of the target vehicle based on the foregoing information.

(3) Receive parking related information of the target vehicle sent by the target vehicle, where the parking related information of the target vehicle includes one or more of a parking space direction, target vehicle information, obstacle information, and target parking space information, the target vehicle information includes an identifier of the target vehicle or a location and a size of the target vehicle, the obstacle information includes an identifier of an obstacle or a location and a size of an obstacle, and the target parking space information includes an identifier of a target parking space or a location and a size of a target parking space; and determine the predicted moving space of the target vehicle during the parking period of the target vehicle based on the parking related information of the target vehicle.

For the parking related information, if there is an obstacle around the target vehicle, the obstacle needs to be considered when the predicted moving space of the target vehicle is determined. To be specific, an obstacle around a vehicle body needs to be detected, so that the finally determined predicted moving space does not include space occupied by the obstacle. If there is no obstacle, there is no need to obtain obstacle information. If no parking space direction is selected for the target vehicle, in other words, a parking space direction is random, the target vehicle may not send a parking space direction to the management device, and the management device may randomly select a parking space direction for the target vehicle. In addition, if no target parking space is selected for the target vehicle, the target vehicle may not send target parking space information to the management device, and the management device may still select a target parking space for the target vehicle.

For the target vehicle information, the obstacle information, and the target parking space information, the target vehicle may send the related identifiers to the management device, and the management device may determine the locations and the sizes based on the identifiers and a pre-stored parking lot map or an existing database; or the target vehicle may directly send the locations and sizes to the management device.

In implementation, the target vehicle may send the parking related information of the target vehicle during the parking period of the target vehicle to the management device. The parking related information of the target vehicle includes one or more of the parking space direction, the target vehicle information, the obstacle information, and the target parking space information, the target vehicle information includes the identifier of the target vehicle or the location and the size of the target vehicle, the obstacle information includes the identifier of the obstacle or the location and the size of the obstacle, and the target parking space information includes the identifier of the target parking space or the location and the size of the target parking space.

Different from case (1) in which the predicted moving space of the target vehicle during the parking period of the target vehicle is directly sent to the management device, in this case, the target vehicle sends, to the management device, all information used to determine the predicted moving space of the target vehicle during the parking period of the target vehicle, and the management device determines the predicted moving space of the target vehicle during the parking period of the target vehicle based on the information. Specifically, the target vehicle may send the parking related information of the target vehicle during the parking period of the target vehicle to the management device.

A current orientation of the target vehicle, the current location of the target vehicle, and the target parking space information not only may be obtained in a same way as that described in case (1), but also may be obtained by using a monitor installed at a parking place. For example, a license plate identifier of the target vehicle is sent to the management device in a parking request initiated by the target vehicle, and the management device identifies the target vehicle in a picture captured by the monitor at the parking place, and further determines the current orientation of the target vehicle, the current location of the target vehicle, and the target parking space information. Another way to obtain the target parking space information is to pre-store a map of the parking place in the management device, where the map includes information such as a location, a size, an orientation, and an identifier of each parking space. In this case, the parking space identifier of the target parking space may be sent to the management device in the parking request. After determining the parking space identifier of the target parking space, the management device can determine the parking space location, the parking space size, and the parking space orientation of the target parking space.

In case (3), the management device may or may not deliver a predicted moving track generated by the management device to the target vehicle. If the management device delivers the generated predicted moving track to the target vehicle, the target vehicle may be parked according to the received predicted moving track. In this case, the predicted moving track determined by the management device is consistent with an actual parking route of the target vehicle. If the predicted moving track is not delivered, the target vehicle may generate a parking route in the target vehicle. In this case, the predicted moving track determined by the management device may be inconsistent with the actual parking route of the target vehicle. In this case, an algorithm used for predicted moving track calculation by the management device needs to be as consistent as possible with an algorithm used for parking route calculation by the target vehicle, so that an obtained predicted moving track is more likely to be consistent with an obtained parking route. For different cases, adjustment may be made based on an actual need in actual application, so that the predicted moving track determined by the management device is ultimately as consistent as possible with the actual parking route of the target vehicle.

Step S220. If the predicted moving space of the target vehicle overlaps with predicted moving space of at least one target object, the management device determines, as a conflicting target object, the target object whose predicted moving space overlaps with that of the target vehicle.

In implementation, the management device compares the predicted moving space of the target vehicle with the predicted moving space of the target object one by one. If the predicted moving space of the target vehicle overlaps with the predicted moving space of the at least one target object, the management device determines, as the conflicting target object, the target object whose predicted moving space overlaps with that of the target vehicle.

Step S230. The management device determines moving priorities of the target vehicle and the conflicting target object according to a preset rule, and sends a moving order coordination instruction to the target vehicle and the conflicting target object based on the moving priorities.

In implementation, if the predicted moving space of the target vehicle overlaps with the predicted moving space of the conflicting target object, the moving priorities of the target vehicle and the conflicting target object are determined according to the preset rule, and the moving order coordination instruction is sent to the target vehicle and the conflicting target object according to the moving priorities.

In implementation, there are a plurality of ways to determine a moving route of an object. Optionally, the target object includes a pedestrian and a vehicle. The vehicle may be further classified into a vehicle driving out of a parking space and a vehicle driving into a parking space. The step of determining predicted moving space of the target object during a parking period of the target vehicle may include: receiving the predicted moving space that is of the target object during the parking period of the target vehicle and that is sent by the target object; or receiving a predicted moving track of the target object during the parking period of the target vehicle and a size of the target object that are sent by the target object, and determining the predicted moving space of the target object during the parking period of the target vehicle based on the predicted moving track and the size of the target object; or receiving moving related information of the target object sent by the target object, where the moving related information of the target object includes a moving destination location and target object information, and the target object information includes an identifier of the target object or a location and a size of the target object, and determining the predicted moving space of the target object during the parking period of the target vehicle based on the moving related information of the target object.

The pedestrian may be a pedestrian picking up a car at a parking lot. When the target object is a pedestrian, a moving route of the pedestrian is a moving route determined by the management device based on a location of a terminal carried by the pedestrian and a location of a vehicle corresponding to the terminal when the management device receives a car pick-up notification sent by the terminal. When the pedestrian enters the parking lot, the pedestrian is easy to get lost or has difficulty in finding a place at which the car is parked because the parking lot is usually relatively large and has no apparent distinguishers for identifying places. In this case, the pedestrian may search for a license plate number of the vehicle of the pedestrian by using a mobile phone, and the management device can help determine the parking location of the vehicle of the pedestrian, and generate a walking route from the pedestrian to the parking location of the vehicle of the pedestrian, to guide the pedestrian to the vehicle of the pedestrian. When the walking route from the pedestrian to the parking location of the vehicle of the pedestrian is generated, a predicted moving track of the pedestrian may be determined based on a moving destination location of the pedestrian. For a pedestrian coming out of a parking lot, a walking route from the pedestrian to a target exit may be generated, and a predicted moving track of the pedestrian may be determined. After the predicted moving track is determined, predicted moving space of the pedestrian is determined based on a body size of the pedestrian or a default average body size of a pedestrian.

A predicted moving track of the vehicle driving out of the parking space is a predicted moving track obtained by the management device from a driving-out-of-parking-space notification when the management device receives the driving-out-of-parking-space notification sent by the vehicle driving out of the parking space. If the vehicle is self-driven, a driver may enter a destination on a vehicular human-vehicle interaction interface, and the vehicle may automatically calculate a driving route, including a route of driving out of the current parking space. If the vehicle is manually driven, the management device may send a moving route guide message to the vehicle driving out of the parking space, to directly instruct a driver how to drive out of the current parking space and how to drive out of the parking lot thereafter. In this case, the management device can determine the predicted moving track of the vehicle driving out of the parking space. Alternatively, the driver is directly asked about how to drive out of the current parking space, and the driver may enter a moving destination location of the driver on a vehicular human-vehicle interaction interface. The vehicle driving out of the parking space reports the moving destination location entered by the driver to the management device.

For the vehicle driving into the parking space, the management device may obtain predicted moving space of the vehicle driving into the parking space in a way similar to one of the three ways to determine the predicted moving space of the target vehicle during the parking period of the target vehicle that are described in this embodiment, or in another feasible way. It should be noted that for the vehicle driving into the parking space, a moving destination location may be the parking space location described in case (3), and object information may be the vehicle size described in case (3). The predicted moving space of the vehicle driving into the parking space may be determined based on the parking related information, apart from the foregoing information.

If the predicted moving space of the target vehicle overlaps with the predicted moving space of the conflicting target object, the management device determines the moving priorities of the target vehicle and the conflicting target object according to the preset rule. The preset rule includes at least one of the following rules, and a preset priority of each rule:

(1) a moving priority of the pedestrian is higher than that of the vehicle;

(2) a moving priority of a vehicle driving out of a parking space is higher than that of a vehicle driving into a parking space;

(3) a moving priority of a disabled pedestrian is higher than that of a non-disabled pedestrian;

(4) a moving priority of an emergency vehicle is higher than that of a non-emergency vehicle;

(5) a moving priority of a public vehicle is higher than that of a non-public vehicle; and

(6) moving priorities of pedestrians with a same attribute or vehicles with a same attribute are randomly allocated.

Settings of the preset rule may be adjusted depending on actual application. The preset rule may be that moving priorities are (4), (3), (1), (5). (2), (6) in descending order. The emergency vehicle may include an ambulance, a fire truck, a police car, and the like. The public vehicle may include a bus, a tourist bus, and the like.

Optionally, the step of sending a moving order coordination instruction to the target vehicle and the conflicting target object based on the moving priorities may include: sending a suspend-parking instruction to the target vehicle when a moving priority of any about-to-move conflicting target object of the conflicting target object is higher than that of the target vehicle; and sending a continue-parking instruction to the target vehicle after all conflicting target objects of the conflicting target object whose moving priorities are higher than that of the target vehicle have moved out of the predicted moving space of the target vehicle.

The moving priority of the conflicting target object is not necessarily higher than the moving priority of the target vehicle. Therefore, if the target vehicle is used as a reference, a conflicting target object whose moving priority is higher than the moving priority of the target vehicle is an about-to-move conflicting target object. In addition, there is not necessarily only one about-to-move conflicting target object. Therefore, the suspend-parking instruction is sent to the target vehicle when the moving priority of any about-to-move conflicting target object is higher than that of the target vehicle.

In implementation, the driver may have triggered generation of an automatic parking instruction, so that the vehicle is automatically parked into the target parking space. In this case, if there is no intervention in the target vehicle, the target vehicle may perform automatic parking. If the moving priority of the target vehicle is the highest, the management device may not intervene in a parking process of the target vehicle. Specifically, the management device may not send any instruction to the target vehicle. Certainly, the management device may alternatively send a parking reminder indication to the target vehicle, to remind the driver that the management device has accepted a parking request sent by the target vehicle and confirmed that parking of the target vehicle is allowed.

If the moving priority of the target vehicle is lower than that of any conflicting target object, an automatic parking process of the target vehicle needs to be suspended, and the management device may intervene in the automatic parking process of the target vehicle. The management device may send the suspend-parking instruction to the target vehicle. The management device sends the continue-parking instruction to the target vehicle after all the conflicting target objects of the conflicting target object whose moving priorities are higher than that of the target vehicle have moved out of the predicted moving space of the target vehicle.

It should be noted that if logic preset in the target vehicle is that after the automatic parking instruction is triggered and generated, if an instruction confirming that parking of the target vehicle is allowed sent by the management device is not received, the target vehicle waits for the instruction. Therefore, when the moving priority of the target vehicle is the highest, the management device needs to deliver the instruction confirming that parking of the target vehicle is allowed.

In implementation, in a moving process of the target object, for example, a walking process of the pedestrian, if the pedestrian carries a mobile phone, and the mobile phone has a positioning function, the management device can obtain positioning information of the mobile phone carried by the pedestrian to determine a location of the pedestrian. For a vehicle with a vehicle-mounted positioning apparatus, the management device may obtain positioning information of the vehicle-mounted positioning apparatus to determine a location of the vehicle. In an underground garage, a GPS signal and a mobile signal are usually relatively weak, accurate positioning cannot be performed. In this case, a location of the target object may be determined with reference to an image captured by a monitor. The management device sends the continue-parking instruction to the target vehicle after determining that all the conflicting target objects of the conflicting target object whose moving priorities are higher than that of the target vehicle have moved out of the predicted moving space of the target vehicle.

Further, to ensure traffic safety, it may be set that the management device sends the continue-parking instruction to the target vehicle after all the conflicting target objects of the conflicting target object whose moving priorities are higher than that of the target vehicle have moved a preset distance from the predicted moving space of the target vehicle.

Step S240. The target vehicle receives, during the parking period of the target vehicle, the moving order coordination instruction sent by the management device, and performs parking processing according to the moving order coordination instruction.

In implementation, the target vehicle suspends parking when receiving the suspend-parking instruction sent by the management device. The target vehicle continues parking when receiving the continue-parking instruction sent by the management device.

Optionally, the target vehicle sends a parking start notification to the management device when the target vehicle starts a parking operation. The target vehicle sends a parking end notification to the management device when a parking operation ends. Correspondingly, when receiving the parking start notification sent by the target vehicle, the management device sends, to the target object or the conflicting target object, a reminder indicating that parking of the target vehicle starts; or starts to send, to the target object or the conflicting target object according to a predetermined cycle, a reminder indicating that the target vehicle is being parked. When receiving the parking end notification sent by the target vehicle, the management device sends, to the target object or the conflicting target object, a reminder indicating that parking of the target vehicle ends; or stops sending, to the target object or the conflicting target object according to a predetermined cycle, a reminder indicating that the target vehicle is being parked.

Furthermore, when the management device sends the continue-parking instruction to the target vehicle, if the target vehicle is an automatic parking vehicle, the target vehicle starts automatic parking. To be specific, when sending the continue-parking instruction to the target vehicle, the management device may determine that the target vehicle is to be parked; and in this case, may send, to the target object, the reminder indicating that parking of the target vehicle starts. For example, the reminder indicating that parking of the target vehicle starts is sent to a transportation participant around the target vehicle, so as to remind a pedestrian or another driver that parking of the target vehicle starts and to keep a distance from the target vehicle. Optionally, after the target object receives a parking reminder message, the pedestrian or the another driver may be reminded in a form of text information, sound, light, or the like.

The following uses a specific example to describe in detail the method provided in this embodiment.

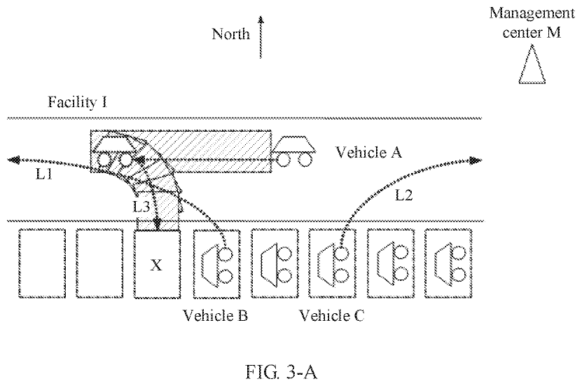

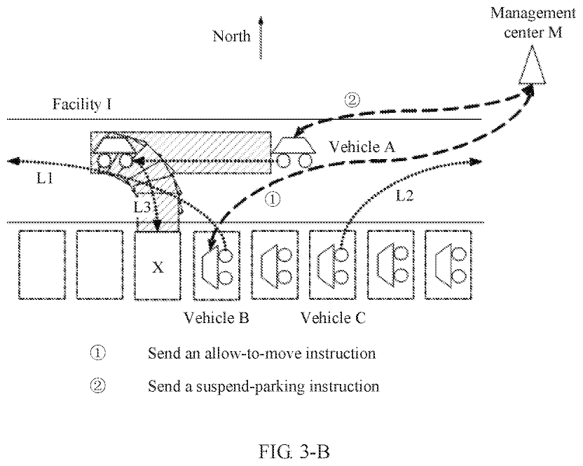

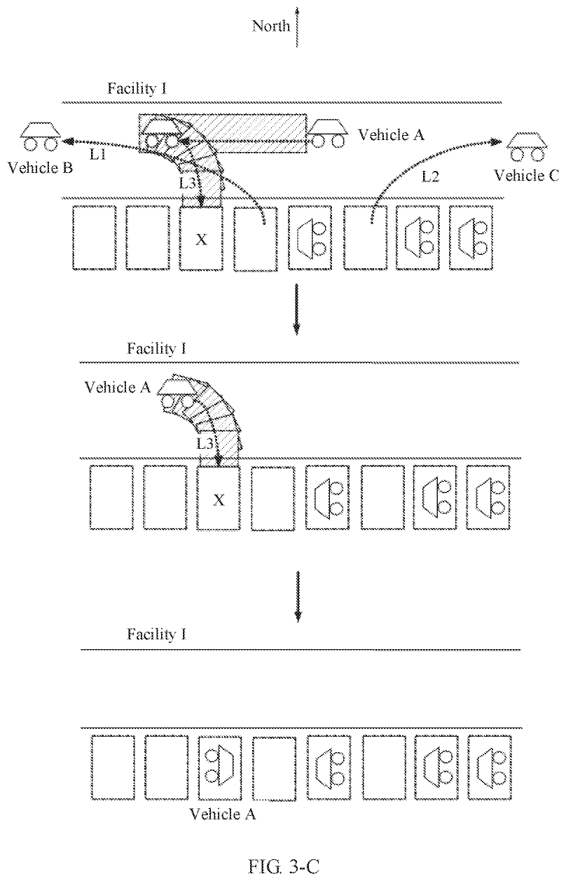

As shown in FIG. 3-A, a facility I is an obstacle, in other words, an area that needs to be avoided by a target vehicle A during parking. A management center M is a place at which a management device is disposed. A target parking space is a parking space X, and the target vehicle A is parked along a line L3. A vehicle B in a parking area is a target object and moves along a line L1 after the vehicle B is started. A vehicle C in the parking area is a target object and moves along a line L2 after the vehicle C is started.

When the target vehicle A is to be parked, a parking request is sent to the management center M. The target vehicle A may send an identifier of the target parking space X to the management center M. Alternatively, the management center M may designate the target parking space X for the target vehicle A. If the target vehicle A sends the identifier of the target parking space X to the management center M, the management center M may determine a location of the target parking space X in a pre-stored map of a parking place based on the identifier of the target parking space X, and query information about the target parking space X in a database. The target parking space X is in a south-north orientation. The management center M may learn that a parking orientation of the target vehicle A is north in FIG. 3-A and that a current orientation of the target vehicle A is west, and obtain a current location of the target vehicle A. The location may be proactively reported by the target vehicle A, or may be directly obtained from the target vehicle. Based on the foregoing information, the management center M may further include the facility I in a parking route determining scope, and may finally determine that the target vehicle A continues to drive westward for a distance beyond the target parking space X in a horizontal direction, and is then backed in a south-east direction. It is determined that a final parking route is the line L3. The management center M may also put a parking tag to the target vehicle A and remove the tag after parking of the target vehicle A is completed.

The management center M may determine, based on the current location of the target vehicle A, that objects whose distances from the target vehicle A are less than the preset threshold, namely, target objects, include the vehicle B and the vehicle C. It should be noted that other vehicles in FIG. 3-A are not started and therefore are not considered.

After determining that the target objects are the vehicle B and the vehicle C, the management center M may determine moving routes of the vehicle B and the vehicle C. Specifically, the management center M may send a moving route obtaining message to the vehicle B and the vehicle C. After the vehicle B and the vehicle C receive the message, a reminder reading “In which direction will you drive after driving out of the parking space?” may be displayed on a vehicular human-vehicle interaction interface. In addition, two option buttons, for example, “west” and “east”, may be provided. In FIG. 3-A, a driver of the vehicle B selects “west” and a driver of the vehicle C selects “east”. The vehicle B and the vehicle C respectively report the choices of the two drivers to the management device. The management device determines, based on the reported information, that the moving routes of the vehicle B and the vehicle C are respectively the line L1 and the line L2.

After determining the line L1, the line L2, and the line L3, the management center M determines, based on vehicle sizes of the vehicle A, the vehicle B, and the vehicle C, predicted moving space corresponding to the line L1, predicted moving space corresponding to the line L2, and predicted moving space corresponding to the line L3. The predicted moving space corresponding to the line L1, the predicted moving space corresponding to the line L2, and the predicted moving space corresponding to the line L3 are compared to determine whether the predicted moving space corresponding to the line L1, the predicted moving space corresponding to the line L2, and the predicted moving space corresponding to the line L3 overlap. It is determined that the predicted moving space corresponding to the line L3 does not overlap with the predicted moving space corresponding to the line L2, but the predicted moving space corresponding to the line L3 overlaps with the predicted moving space corresponding to the line L1. The management center M needs to coordinate a moving order between the target vehicle A and the vehicle B. According to a preset moving priority rule, a to-be-parked vehicle, namely the target vehicle A, moves after the vehicle B driving out of a parking space has moved out. In this case, as shown in FIG. 3-B, the management center M may send an allow-to-move instruction to the vehicle B, and the vehicle B may directly drive out of the parking space. The management center M sends a suspend-parking instruction to the target vehicle A. When the management center M determines that the vehicle B has moved out of an overlapping area between the vehicle B and the target vehicle A and is at a safe distance, as shown in an upper diagram in FIG. 3-C, the management center M sends a continue-parking instruction to the target vehicle A, instructing the target vehicle A to advance a distance westward, as shown in a middle diagram in FIG. 3-C. The target vehicle A may continue parking after receiving the continue-parking instruction. As shown in a lower diagram in FIG. 3-C, when ending parking, the target vehicle A may send a parking end notification to the management center M. After receiving the parking end notification, the management center M may remove the parking tag from the target vehicle A.

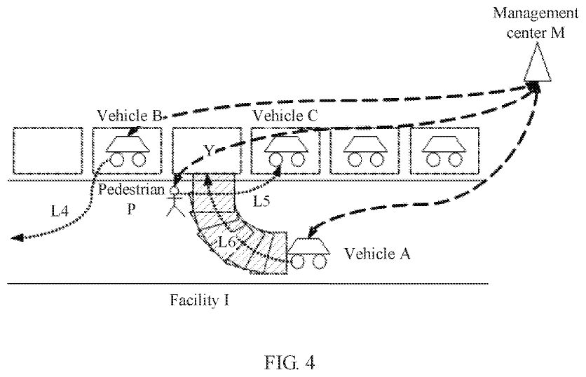

In addition, as shown in FIG. 4, a facility I is an obstacle, in other words, an area that needs to be avoided by a target vehicle A during parking. A management center M is a place at which a management device is disposed. A target parking space is a parking space Y, and the target vehicle A is parked along a line L6. A vehicle B in a parking area is a target object and moves along a line L4 after the vehicle B is started. A pedestrian P is a target object and is to pick up a vehicle C parked in the parking area. The pedestrian P moves along a line L5 to go to pick up the vehicle C. In this case, predicted moving space corresponding to the line L6 does not overlap with predicted moving space corresponding to the line L4, but the predicted moving space corresponding to the line L6 overlaps with predicted moving space corresponding to the line L5, in other words, predicted moving space of the target vehicle A overlaps with a walking route of the pedestrian. According to a pedestrian first principle, the target vehicle A may move after the pedestrian P finishes moving.

The target vehicle and the target object are scheduled in a coordinated manner, so that the target vehicle and the target object can avoid a collision between a to-be-parked vehicle and a vehicle or a pedestrian caused by a lack of knowledge of each other's planned moving route, thereby improving parking safety and efficiency.

Manual parking function-based parking of a target vehicle is used as a specific implementation below to describe a processing procedure in FIG. 2 in detail. Details may be as follows.

Step S210. A management device determines predicted moving space of the target vehicle and predicted moving space of a target object during a parking period of the target vehicle, where the target object is an object whose distance from the target vehicle is less than a preset threshold.

In implementation, the target vehicle is a vehicle that requires manual parking. When a driver intends to park the target vehicle, the driver may select, on a vehicular human-vehicle interaction interface, a trigger button for sending a parking request to the management device. Certainly, the driver may directly say a preset utterance to a voice recognition system. When recognizing that the driver intends to park, the voice recognition system triggers sending of a parking request to the management device. Alternatively, when detecting that any vehicle driving into a managed area such as a parking lot is near a parking space, the management device may trigger an operation of determining the predicted moving space of the target vehicle and the predicted moving space of the target object during the parking period of the target vehicle.

Step S220. If the predicted moving space of the target vehicle overlaps with predicted moving space of at least one target object, the management device determines, as a conflicting target object, the target object whose predicted moving space overlaps with that of the target vehicle.

In implementation, the management device may receive the predicted moving space that is of the target vehicle during the parking period of the target vehicle and that is sent by the target vehicle. Alternatively, the management device may receive a predicted moving track of the target vehicle during the parking period of the target vehicle and a size of the target vehicle that are sent by the target vehicle, and determine the predicted moving space of the target vehicle during the parking period of the target vehicle based on the predicted moving track of the target vehicle and the size of the target vehicle. Alternatively, the management device may receive parking related information of the target vehicle sent by the target vehicle, where the parking related information of the target vehicle includes one or more of a parking space direction, target vehicle information, obstacle information, and target parking space information, the target vehicle information includes an identifier of the target vehicle or a location and a size of the target vehicle, the obstacle information includes an identifier of an obstacle or a location and a size of an obstacle, and the target parking space information includes an identifier of a target parking space or a location and a size of a target parking space; and determine the predicted moving space of the target vehicle during the parking period of the target vehicle based on the parking related information of the target vehicle.

Optionally, the target object includes a pedestrian and a vehicle. The vehicle may be further classified into a vehicle driving out of a parking space and a vehicle driving into a parking space. The step of determining predicted moving space of the target object during a parking period of the target vehicle may include: receiving the predicted moving space that is of the target object during the parking period of the target vehicle and that is sent by the target object; or receiving a predicted moving track of the target object during the parking period of the target vehicle and a size of the target object that are sent by the target object, and determining the predicted moving space of the target object during the parking period of the target vehicle based on the predicted moving track and the size of the target object; or receiving moving related information of the target object sent by the target object, where the moving related information of the target object includes a moving destination location and target object information, and the target object information includes an identifier of the target object or a location and a size of the target object, and determining the predicted moving space of the target object during the parking period of the target vehicle based on the moving related information of the target object.

Step S230. The management device determines moving priorities of the target vehicle and the conflicting target object according to a preset rule, and sends a moving order coordination instruction to the target vehicle and the conflicting target object based on the moving priorities.

If the predicted moving space of the target vehicle overlaps with the predicted moving space of the at least one target object, the management device determines the moving priorities of the target vehicle and the conflicting target object according to the preset rule. The preset rule includes at least one of the following rules, and a preset priority of each rule:

(1) a moving priority of the pedestrian is higher than that of the vehicle;

(2) a moving priority of a vehicle driving out of a parking space is higher than that of a vehicle driving into a parking space;

(3) a moving priority of a disabled pedestrian is higher than that of a non-disabled pedestrian;

(4) a moving priority of an emergency vehicle is higher than that of a non-emergency vehicle:

(5) a moving priority of a public vehicle is higher than that of a non-public vehicle; and

(6) moving priorities of pedestrians with a same attribute or vehicles with a same attribute are randomly allocated.

Settings of the preset rule may be adjusted depending on actual application. The preset rule may be that moving priorities are (4), (3). (1), (5), (2), (6) in descending order. The emergency vehicle may include an ambulance, a fire truck, a police car, and the like. The public vehicle may include a bus, a tourist bus, and the like.

Optionally, the step of sending a moving order coordination instruction to the target vehicle and the conflicting target object based on the moving priorities may include: sending a suspend-parking instruction to the target vehicle when a moving priority of any about-to-move conflicting target object of the conflicting target object is higher than that of the target vehicle; and sending a continue-parking instruction to the target vehicle after all conflicting target objects of the conflicting target object whose moving priorities are higher than that of the target vehicle have moved out of the predicted moving space of the target vehicle.

Step S240. The target vehicle receives, during the parking period of the target vehicle, the moving order coordination instruction sent by the management device, and performs parking processing according to the moving order coordination instruction.

In implementation, the management device may send the suspend-parking instruction to the target vehicle. After receiving the suspend-parking instruction, the target vehicle may display “Please wait” on the vehicular human-vehicle interaction interface, or broadcast “Please wait” in a voice broadcasting manner. When seeing or hearing the message, the driver may pull over the target vehicle at the current location through a manual operation, for example, putting the vehicle in neutral, and wait for a next instruction from the management device.

In implementation, when receiving a continue-parking instruction sent by the management device, the target vehicle may display “Please continue parking” on the vehicular human-vehicle interaction interface, or broadcast “Please continue parking” in a voice broadcasting manner. When seeing or hearing the message, the driver may continue parking through a manual operation.

The target vehicle and the target object are scheduled in a coordinated manner, so that the target vehicle and the target object can avoid a collision between a to-be-parked vehicle and a vehicle or a pedestrian caused by a lack of knowledge of each other's planned moving route, thereby improving parking safety and efficiency.

Another example embodiment of this application provides a moving control apparatus. The apparatus provided in this embodiment may be applied to the management device in the foregoing embodiment. As shown in FIG. 5, the apparatus includes:

a first determining module 510, configured to determine predicted moving space of a target vehicle and predicted moving space of a target object during a parking period of the target vehicle, where the target object is an object whose distance from the target vehicle is less than a preset threshold, and the first determining module 510 may specifically implement the determining function in step S210 in the foregoing embodiment and other implicit steps;

a second determining module 520, configured to: when the predicted moving space of the target vehicle overlaps with predicted moving space of at least one target object, determine, as a conflicting target object, the target object whose predicted moving space overlaps with that of the target vehicle, where the second determining module 520 may specifically implement the determining function in step S220 in the foregoing embodiment and other implicit steps:

a third determining module 530, configured to determine moving priorities of the target vehicle and the conflicting target object according to a preset rule; and

a sending module 540, configured to send a moving order coordination instruction to the target vehicle and the conflicting target object based on the moving priorities, where the sending module 540 may specifically implement the sending function in step S230 in the foregoing embodiment and other implicit steps.

In a possible implementation, the first determining module 510 is configured to receive the predicted moving space that is of the target vehicle during the parking period of the target vehicle and that is sent by the target vehicle; or receive a predicted moving track of the target vehicle during the parking period of the target vehicle and a size of the target vehicle that are sent by the target vehicle, and determine the predicted moving space of the target vehicle during the parking period of the target vehicle based on the predicted moving track of the target vehicle and the size of the target vehicle; or receive parking related information of the target vehicle sent by the target vehicle, where the parking related information of the target vehicle includes one or more of a parking space direction, target vehicle information, obstacle information, and target parking space information, the target vehicle information includes an identifier of the target vehicle or a location and a size of the target vehicle, the obstacle information includes an identifier of an obstacle or a location and a size of an obstacle, and the target parking space information includes an identifier of a target parking space or a location and a size of a target parking space, and determine the predicted moving space of the target vehicle during the parking period of the target vehicle based on the parking related information of the target vehicle.

In a possible implementation, the first determining module 510 is configured to receive the predicted moving space that is of the target object during the parking period of the target vehicle and that is sent by the target object; or receive a predicted moving track of the target object during the parking period of the target vehicle and a size of the target object that are sent by the target object, and determine the predicted moving space of the target object during the parking period of the target vehicle based on the predicted moving track of the target object and the size of the target object; or receive moving related information of the target object sent by the target object, where the moving related information of the target object includes a moving destination location and target object information, and the target object information includes an identifier of the target object or a location and a size of the target object, and determine the predicted moving space of the target object during the parking period of the target vehicle based on the moving related information of the target object.

In a possible implementation, the target object includes a pedestrian and a vehicle, and the preset rule includes at least one of the following rules, and a preset priority of each rule:

a moving priority of the pedestrian is higher than that of the vehicle;

a moving priority of a vehicle driving out of a parking space is higher than that of a vehicle driving into a parking space:

a moving priority of a disabled pedestrian is higher than that of a non-disabled pedestrian;

a moving priority of an emergency vehicle is higher than that of a non-emergency vehicle;

a moving priority of a public vehicle is higher than that of a non-public vehicle; and moving priorities of pedestrians with a same attribute or vehicles with a same attribute are randomly allocated.

In a possible implementation, the sending module 540 is configured to send a suspend-parking instruction to the target vehicle when a moving priority of any about-to-move conflicting target object of the conflicting target object is higher than that of the target vehicle; and send a continue-parking instruction to the target vehicle after all conflicting target objects of the conflicting target object whose moving priorities are higher than that of the target vehicle have moved out of the predicted moving space of the target vehicle.

In a possible implementation, the sending module 540 is further configured to: when a parking start notification sent by the target vehicle is received, send, to the target object or the conflicting target object, a reminder indicating that parking of the target vehicle starts; or start to send, to the target object or the conflicting target object according to a predetermined cycle, a reminder indicating that the target vehicle is being parked.

In a possible implementation, the sending module 540 is further configured to: when a parking end notification sent by the target vehicle is received, send, to the target object or the conflicting target object, a reminder indicating that parking of the target vehicle ends; or stop sending, to the target object or the conflicting target object according to a predetermined cycle, a reminder indicating that the target vehicle is being parked.

It should be noted that the first determining module 510, the second determining module 520, the third determining module 530, and the sending module 540 may be implemented by a processor, or may be implemented by a processor in cooperation with a memory, or may be implemented by a processor by executing a program instruction in a memory.

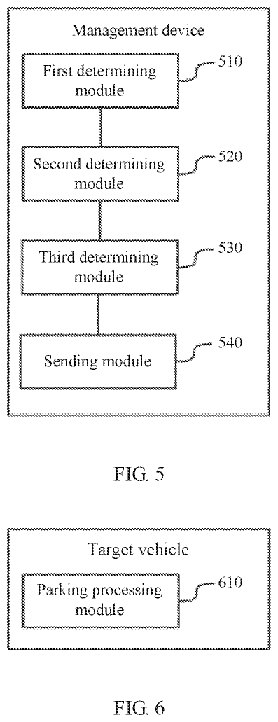

Still another example embodiment of this application provides a moving control apparatus. The apparatus provided in this embodiment may be applied to the target vehicle in the foregoing embodiment. As shown in FIG. 6, the apparatus includes:

a parking processing module 610, configured to receive, during a parking period of the target vehicle, a moving order coordination instruction sent by a management device, and perform parking processing according to the moving order coordination instruction, where the parking processing module 610 may specifically implement the parking processing function in step S240 in the foregoing embodiment and other implicit steps.

In a possible implementation, the apparatus further includes:

a sending module, configured to send predicted moving space of the target vehicle during the parking period of the target vehicle to the management device, where the predicted moving space of the target vehicle is determined based on parking related information of the target vehicle, the parking related information of the target vehicle includes one or more of a parking space direction, target vehicle information, obstacle information, and target parking space information, the target vehicle information includes a location and a size of the target vehicle, the obstacle information includes a location and a size of an obstacle, and the target parking space information includes a location and a size of a target parking space; or send a predicted moving track of the target vehicle during the parking period of the target vehicle and a size of the target vehicle to the management device, where the predicted moving track of the target vehicle is determined based on one or more of a parking space direction of the target vehicle, a location of the target vehicle, obstacle information, and target parking space information; or send parking related information of the target vehicle during the parking period of the target vehicle to the management device, where the parking related information of the target vehicle includes one or more of a parking space direction, target vehicle information, obstacle information, and target parking space information, the target vehicle information includes an identifier of the target vehicle or a location and a size of the target vehicle, the obstacle information includes an identifier of an obstacle or a location and a size of an obstacle, and the target parking space information includes an identifier of a target parking space or a location and a size of a target parking space.

In a possible implementation, the parking processing module 610 is configured to: during the parking period of the target vehicle, suspend parking when a suspend-parking instruction sent by the management device is received; and during the parking period of the target vehicle, continue parking when a continue-parking instruction sent by the management device is received.

In a possible implementation, the sending module is further configured to send a parking start notification to the management device when the target vehicle starts a parking operation.

In a possible implementation, the sending module is further configured to send a parking end notification to the management device when the target vehicle ends a parking operation.

It should be noted that the parking processing module 610 may be implemented by a processor, or may be implemented by a processor in cooperation with a memory, or may be implemented by a processor by executing a program instruction in a memory.

For the apparatus in the foregoing embodiment, a specific operation manner of each module has been described in detail in the related method embodiment. Details are not described herein.

With the apparatus provided in this embodiment, the target vehicle and the target object are scheduled in a coordinated manner, so that the target vehicle and the target object can avoid a collision between a to-be-parked vehicle and a vehicle or a pedestrian caused by a lack of knowledge of each other's planned moving route, thereby improving parking safety and efficiency.

It should be noted that when the moving control apparatus provided in the foregoing embodiment performs parking control, division of the foregoing functional modules is merely used as an example for description. In actual application, the foregoing functions may be allocated to and completed by different functional modules based on a need. To be specific, an internal structure of the management device or the vehicle is divided into different functional modules to implement all or some of the functions described above. In addition, the moving control apparatus provided in the foregoing embodiment is based on an idea same as that in the embodiment of the moving control method. For a specific implementation process of the moving control apparatus, refer to the method embodiment. Details are not described herein again.

Yet another example embodiment of this application provides a moving control system. The system includes a management device and a target vehicle.

The management device is configured to determine predicted moving space of the target vehicle and predicted moving space of a target object during a parking period of the target vehicle, where the target object is an object whose distance from the target vehicle is less than a preset threshold; if the predicted moving space of the target vehicle overlaps with predicted moving space of at least one target object, determine, as a conflicting target object, the target object whose predicted moving space overlaps with that of the target vehicle; and determine moving priorities of the target vehicle and the conflicting target object according to a preset rule, and send a moving order coordination instruction to the target vehicle and the conflicting target object based on the moving priorities.

The target vehicle is configured to receive, during the parking period of the target vehicle, the moving order coordination instruction sent by the management device, and perform parking processing according to the moving order coordination instruction.

For the system in the foregoing embodiment, specific operation manners of the management device and the target vehicle have been described in detail in the related method embodiment. Details are not described herein.

A person skilled in the art should be aware that in the foregoing one or more examples, functions described in the embodiments of this application may be implemented by hardware, software, firmware, or any combination thereof. When software is used for implementation, the functions may be stored in a computer readable medium or transmitted as one or more instructions or code in the computer readable medium. The computer readable medium includes a computer storage medium and a communications medium. The communications medium includes any medium that enables a computer program to be transmitted from one place to another. The storage medium may be any available medium accessible to a general-purpose or dedicated computer.

In the foregoing specific implementations, the objectives, technical solutions, and benefits of the embodiments of this application are further described in detail. It should be understood that the foregoing descriptions are merely specific implementations of the embodiments of this application, but are not intended to limit the protection scope of the embodiments of this application. Any modification, equivalent replacement, or improvement made based on technical solutions of the embodiments of this application shall fall within the protection scope of the embodiments of this application.

What is claimed is:

1. A moving control method, wherein the method comprises:
determining predicted moving space of a target vehicle and predicted moving space of a target object during a parking period of the target vehicle, wherein the target object is an object whose distance from the target vehicle is less than a preset threshold;
if the predicted moving space of the target vehicle overlaps with predicted moving space of at least one target object, determining, as a conflicting target object, the target object whose predicted moving space overlaps with that of the target vehicle; and
determining moving priorities of the target vehicle and the conflicting target object according to a preset rule, and sending a moving order coordination instruction to the target vehicle and the conflicting target object based on the moving priorities.

2. The method according to claim 1, wherein the determining predicted moving space of a target vehicle during a parking period of the target vehicle comprises:
receiving the predicted moving space that is of the target vehicle during the parking period of the target vehicle and that is sent by the target vehicle; or
receiving a predicted moving track of the target vehicle during the parking period of the target vehicle and a size of the target vehicle that are sent by the target vehicle, and determining the predicted moving space of the target vehicle during the parking period of the target vehicle based on the predicted moving track of the target vehicle and the size of the target vehicle; or
receiving parking related information of the target vehicle sent by the target vehicle, wherein the parking related information of the target vehicle comprises one or more of a parking space direction, target vehicle information, obstacle information, and target parking space information, the target vehicle information comprises an identifier of the target vehicle or a location and a size of the target vehicle, the obstacle information comprises an identifier of an obstacle or a location and a size of an obstacle, and the target parking space information comprises an identifier of a target parking space or a location and a size of a target parking space; and determining the predicted moving space of the target vehicle during the parking period of the target vehicle based on the parking related information of the target vehicle.

3. The method according to claim 1, wherein the determining predicted moving space of a target object during a parking period of the target vehicle comprises:
receiving the predicted moving space that is of the target object during the parking period of the target vehicle and that is sent by the target object; or
receiving a predicted moving track of the target object during the parking period of the target vehicle and a size of the target object that are sent by the target object, and determining the predicted moving space of the target object during the parking period of the target vehicle based on the predicted moving track of the target object and the size of the target object; or
receiving moving related information of the target object sent by the target object, wherein the moving related information of the target object comprises a moving destination location and target object information, and the target object information comprises an identifier of the target object or a location and a size of the target object, and determining the predicted moving space of the target object during the parking period of the target vehicle based on the moving related information of the target object.

4. The method according to claim 1, wherein the target object comprises a pedestrian and a vehicle, and the preset rule comprises at least one of the following rules, and a preset priority of each rule:
a moving priority of the pedestrian is higher than that of the vehicle;
a moving priority of a vehicle driving out of a parking space is higher than that of a vehicle driving into a parking space;
a moving priority of a disabled pedestrian is higher than that of a non-disabled pedestrian;
a moving priority of an emergency vehicle is higher than that of a non-emergency vehicle;
a moving priority of a public vehicle is higher than that of a non-public vehicle; and
moving priorities of pedestrians with a same attribute or vehicles with a same attribute are randomly allocated.

5. The method according to claim 1, wherein the sending a moving order coordination instruction to the target vehicle and the conflicting target object based on the moving priorities comprises:
sending a suspend-parking instruction to the target vehicle when a moving priority of any about-to-move conflicting target object of the conflicting target object is higher than that of the target vehicle; and
sending a continue-parking instruction to the target vehicle after all conflicting target objects of the conflicting target object whose moving priorities are higher than that of the target vehicle have moved out of the predicted moving space of the target vehicle.

6. A moving control method, wherein the method comprises:
receiving, during a parking period of a target vehicle, a moving order coordination instruction sent by a management device, and performing parking processing according to the moving order coordination instruction.

7. The method according to claim 6, wherein the method further comprises:
sending predicted moving space of the target vehicle during the parking period of the target vehicle to the management device, wherein the predicted moving space of the target vehicle is determined based on parking related information of the target vehicle, the parking related information of the target vehicle comprises one or more of a parking space direction, target vehicle information, obstacle information, and target parking space information, the target vehicle information comprises a location and a size of the target vehicle, the obstacle information comprises a location and a size of an obstacle, and the target parking space information comprises a location and a size of a target parking space; or
sending a predicted moving track of the target vehicle during the parking period of the target vehicle and a size of the target vehicle to the management device, wherein the predicted moving track of the target vehicle is determined based on one or more of a parking space direction of the target vehicle, a location of the target vehicle, obstacle information, and target parking space information; or
sending parking related information of the target vehicle during the parking period of the target vehicle to the management device, wherein the parking related information of the target vehicle comprises one or more of a parking space direction, target vehicle information, obstacle information, and target parking space information, the target vehicle information comprises an identifier of the target vehicle or a location and a size of the target vehicle, the obstacle information comprises an identifier of an obstacle or a location and a size of an obstacle, and the target parking space information comprises an identifier of a target parking space or a location and a size of a target parking space.

8. A moving control system, wherein the system comprises a management device and a target vehicle;
the management device is configured to determine predicted moving space of the target vehicle and predicted moving space of a target object during a parking period of the target vehicle, wherein the target object is an object whose distance from the target vehicle is less than a preset threshold; if the predicted moving space of the target vehicle overlaps with predicted moving space of at least one target object, determine, as a conflicting target object, the target object whose predicted moving space overlaps with that of the target vehicle; and determine moving priorities of the target vehicle and the conflicting target object according to a preset rule, and send a moving order coordination instruction to the target vehicle and the conflicting target object based on the moving priorities; and
the target vehicle is configured to receive, during the parking period of the target vehicle, the moving order coordination instruction sent by the management device, and perform parking processing according to the moving order coordination instruction.

9. A management device, wherein the management device comprises a processor, a memory, and a transmitter;
the processor is configured to determine predicted moving space of a target vehicle and predicted moving space of a target object during a parking period of the target vehicle, wherein the target object is an object whose distance from the target vehicle is less than a preset threshold; if the predicted moving space of the target vehicle overlaps with predicted moving space of at least one target object, determine, as a conflicting target object, the target object whose predicted moving space overlaps with that of the target vehicle; and determine moving priorities of the target vehicle and the conflicting target object according to a preset rule stored in the memory; and
the transmitter is configured to send a moving order coordination instruction to the target vehicle and the conflicting target object based on the moving priorities.

10. The management device according to claim 9, wherein the management device further comprises a receiver; and
the receiver is configured to receive the predicted moving space that is of the target vehicle during the parking period of the target vehicle and that is sent by the target vehicle; or
the receiver is configured to receive a predicted moving track of the target vehicle during the parking period of the target vehicle and a size of the target vehicle that are sent by the target vehicle, and determine the predicted moving space of the target vehicle during the parking period of the target vehicle based on the predicted moving track of the target vehicle and the size of the target vehicle; or
the receiver is configured to receive parking related information of the target vehicle sent by the target vehicle, wherein the parking related information of the target vehicle comprises one or more of a parking space direction, target vehicle information, obstacle information, and target parking space information, the target vehicle information comprises an identifier of the target vehicle or a location and a size of the target vehicle, the obstacle information comprises an identifier of an obstacle or a location and a size of an obstacle, and the target parking space information comprises an identifier of a target parking space or a location and a size of a target parking space; and determine the predicted moving space of the target vehicle during the parking period of the target vehicle based on the parking related information of the target vehicle.

11. The management device according to claim 10, wherein the receiver is further configured to receive the predicted moving space that is of the target object during the parking period of the target vehicle and that is sent by the target object; or
the receiver is further configured to receive a predicted moving track of the target object during the parking period of the target vehicle and a size of the target object that are sent by the target object, and determine the predicted moving space of the target object during the parking period of the target vehicle based on the predicted moving track of the target object and the size of the target object; or
the receiver is further configured to receive moving related information of the target object sent by the target object, wherein the moving related information of the target object comprises a moving destination location and target object information, and the target object information comprises an identifier of the target object or a location and a size of the target object, and determine the predicted moving space of the target object during the parking period of the target vehicle based on the moving related information of the target object.

12. The management device according to claim 9, wherein the target object comprises a pedestrian and a vehicle, and the preset rule comprises at least one of the following rules, and a preset priority of each rule:
a moving priority of the pedestrian is higher than that of the vehicle;
a moving priority of a vehicle driving out of a parking space is higher than that of a vehicle driving into a parking space;
a moving priority of a disabled pedestrian is higher than that of a non-disabled pedestrian;
a moving priority of an emergency vehicle is higher than that of a non-emergency vehicle;
a moving priority of a public vehicle is higher than that of a non-public vehicle; and
moving priorities of pedestrians with a same attribute or vehicles with a same attribute are randomly allocated.

13. The management device according to claim 9, wherein the transmitter is configured to send a suspend-parking instruction to the target vehicle when a moving priority of any about-to-move conflicting target object of the conflicting target object is higher than that of the target vehicle; and
the transmitter is configured to send a continue-parking instruction to the target vehicle after all conflicting target objects of the conflicting target object whose moving priorities are higher than that of the target vehicle have moved out of the predicted moving space of the target vehicle.

14. A target vehicle, wherein the target vehicle comprises a receiver and a processor;
the receiver is configured to receive, during a parking period of the target vehicle, a moving order coordination instruction sent by a management device; and
the processor is configured to perform parking processing according to the moving order coordination instruction.

15. The target vehicle according to claim 14, wherein the target vehicle further comprises a transmitter; and
the transmitter is configured to send predicted moving space of the target vehicle during the parking period of the target vehicle to the management device, wherein the predicted moving space of the target vehicle is determined based on parking related information of the target vehicle, the parking related information of the target vehicle comprises one or more of a parking space direction, target vehicle information, obstacle information, and target parking space information, the target vehicle information comprises a location and a size of the target vehicle, the obstacle information comprises a location and a size of an obstacle, and the target parking space information comprises a location and a size of a target parking space; or
the transmitter is configured to send a predicted moving track of the target vehicle during the parking period of the target vehicle and a size of the target vehicle to the management device, wherein the predicted moving track of the target vehicle is determined based on one or more of a parking space direction of the target vehicle, a location of the target vehicle, obstacle information, and target parking space information; or
the transmitter is configured to send parking related information of the target vehicle during the parking period of the target vehicle to the management device, wherein the parking related information of the target vehicle comprises one or more of a parking space direction, target vehicle information, obstacle information, and target parking space information, the target vehicle information comprises an identifier of the target vehicle or a location and a size of the target vehicle, the obstacle information comprises an identifier of an obstacle or a location and a size of an obstacle, and the target parking space information comprises an identifier of a target parking space or a location and a size of a target parking space.

16. A computer readable storage medium comprising an instruction, wherein when the instruction is run on a management device, the management device is enabled to perform the method according to claim 1.

17. A computer program product comprising an instruction, wherein when the computer program product is run on a management device, the management device is enabled to perform the method according to claim 1.

18. A computer readable storage medium comprising an instruction, wherein when the instruction is run on a target vehicle, the target vehicle is enabled to perform the method according to claim 6

19. A computer program product comprising an instruction, wherein when the computer program product is run on a target vehicle, the target vehicle is enabled to perform the method according to claim 6.
